(19) United States
(12) Patent Application Publication
(10) Pub. No.: US 2024/0165686 A1
(43) Pub. Date: May 23, 2024

(54) Adapter and Handle for Pipe Bender Head

(71) Applicant: Justin Pridemore, Victorville, CA (US)

(72) Inventor: Justin Pridemore, Victorville, CA (US)

(21) Appl. No.: 18/195,261

(22) Filed: May 9, 2023

Related U.S. Application Data
(60) Provisional application No. 63/384,227, filed on Nov. 18, 2022.

(51) Int. Cl. B21D 7/16; B21D 7/04; B25G 1/04; B25G 3/02

(52) U.S. Cl. CPC B21D 7/16; B21D 7/04; B25G 1/04; B25G 3/02

(57) ABSTRACT

Adapters and an all-in-one handle to couple with pipe bender heads of different sizes are disclosed. Different pipe bender heads may require differently sized handles that couple to the varying coupling bores of the pipe bender heads. Carrying and having multiple handles on the job site may be cumbersome. Instead of carrying multiple handles, the user may carry adapters that may be used to couple the different pipe bender heads to a single sized handle. The adapters may have a first mating section to couple with the coupling bores of various pipe bender heads and a second mating section to couple with the all-in-one handle.

### CROSS-REFERENCE TO RELATED APPLICATIONS

Not Applicable

### STATEMENT RE: FEDERALLY SPONSORED RESEARCH DEVELOPMENT

Not Applicable

### BACKGROUND

The various embodiments and aspects described herein relate to a set of adapters that can be used to couple differently sized pipe bender heads to a single all-in-one handle.

The bending of electrical metallic tubing (EMT) pipes on project sites is usually done by using an EMT pipe bender tool. Carrying these EMT pipe benders are cumbersome.

Accordingly, there is a need in the art for an improved device, system, and method for a pipe bender assembly that can be manageably transported, stored, and maintained.

### BRIEF SUMMARY

The various embodiments and aspects disclosed herein address the needs discussed above, discussed below and those that are known in the art.

Adapters and a universal handle to couple with pipe bender heads of different sizes are disclosed. The adapters may have first mating sections to couple with the coupling bores of various pipe bender heads and second mating sections to couple with the all-in-one handle. Each adapter may have a first mating section, with distinct dimensions designed to couple to the coupling bore of a pipe bender head having a specific size and shape. On the other hand, the second mating section of the different adapters may all have the same dimensions that correspond to the size and shape of the coupling end of the all-in-one handle. The second mating section of the different adapters may also couple with an original handle of a pipe bender head, specifically an original handle of a large or extra-large pipe bender head. The features and functions of the adapters may also be integrated with the pipe bender heads to reduce the components that the user needs to carry to the project site. The all-in-one handle may be modular and come in different pieces that may be assembled and disassembled for the ease of transportation and storage. The all-in-one handle may also be retractable via a telescoping mechanism, or collapsible using hinges that connect the different shaft parts of the handle.

More particularly, a method for assembling a pipe bender tool for bending a pipe is disclosed. The method may comprise providing a plurality of pipe bender adapters a plurality of pipe bender heads with each pipe bender head capable of bending a different size pipe and attachable to a corresponding pipe bender adapter, a universal handle attachable to each of the plurality of pipe bender adapters. The method may further comprise selecting a desired pipe bender head from the plurality of pipe bender heads that fits the pipe. The method may further comprise selecting a desired adapter from the plurality of pipe bender adapters that fits the selected pipe bender head. The method may further comprise coupling a first mating section of the selected adapter to a coupling bore of the selected pipe bender head, the first mating section having a mating end portion that is threaded and cylindrical to couple with the coupling bore. The method may further comprise coupling a second mating section of the desired adapter with a coupling end of the universal handle, the second mating section having a receiving bore that is threaded to couple with the coupling end of the universal handle.

In some embodiments, the method may further comprise assembling a first modular shaft with a second modular shaft of the universal handle by coupling a connecting end of the second modular shaft with a coupling socket of the first modular shaft prior to coupling the selected adapter with the universal handle.

In some embodiments, the method may further comprise unfolding a first shaft from a second shaft of the universal handle through rotation about a first hinge of the universal handle and unfolding the second shaft from a third shaft through rotation about a second hinge of the universal handle prior to coupling the selected adapter with the universal handle.

In some embodiments, the method may further comprise expanding the universal handle through a telescoping mechanism.

In some embodiments, the method may further comprise uncoupling the universal handle from the selected adapter and coupling the universal handle to a different second mating section of a second selected adapter.

In some embodiments of the method, the selecting of the selected adapter is done by matching a size of the first mating section of the selected adapter with a hole size of the coupling bore of the selected pipe bender head.

In some embodiments, the method may further comprise inserting the mating end portion of the selected adapter through a casing support hole of the selected pipe bender head prior to coupling the mating end portion to the coupling bore.

In some embodiments of the method, the coupling bore and the casing support hole are located between a pipe inlet portion and a foot press portion of the selected pipe bender head.

In some embodiments of the method, the plurality of pipe bender adapters is metallic.

In some embodiments of the method, the universal handle is metallic.

Furthermore, an assembly of a plurality of pipe bender adapters and a universal handle is disclosed. The assembly may comprise a first adapter having a first mating section that is cylindrical and having a first adapter end that is threaded and dimensioned to couple to a first coupling bore of a first pipe bender head, and the first adapter having a second mating section having a first receiving bore that is threaded and dimensioned to couple with the universal handle. The assembly may further comprise a second adapter having a first coupling section that is cylindrical and having a second adapter end that is narrower than the first adapter end of the first adapter and threaded and dimensioned to couple to a second coupling bore of a second pipe bender head having a smaller bore size than the first pipe bender head, and the second adapter having a second coupling section having a second receiving bore having a same size as the first receiving bore of the first adapter. The universal handle may be modular and having a first and a second shaft, the first shaft having a coupling end configured to couple with the first and the second receiving bores of the first and the second adapters.

In some embodiments of the assembly, the second shaft of the universal handle has a connecting end to couple with a coupling socket of the first shaft of the universal handle.

In some embodiments of the assembly, the first shaft of the universal handle is connected to the second shaft of the universal handle by a first hinge configured to allow the first shaft to rotate and fold on the second shaft, and a third shaft of the universal handle connected to the second shaft by a second hinge.

In some embodiments of the assembly, the folded first shaft and the second shaft are configured to rotate about the second hinge such that the coupling end of the first shaft lies on the third shaft.

In some embodiments of the assembly, the third shaft is connected to a fourth shaft by a third hinge such that the first and the second shafts are configured to rotate and fold on the fourth shaft.

In some embodiments of the assembly, the first shaft is configured to retract inside the second shaft through a telescoping mechanism.

In some embodiments of the assembly, the second shaft of the universal handle has an adjusting for receiving bent pipes.

In some embodiments of the assembly, the plurality of pipe bender adapters and the universal handle am configured to be stored in a portable casing.

In some embodiments of the assembly, the plurality of pipe bender adapters is metallic.

In some embodiments of the assembly, the universal handle is metallic.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows the different components of a pipe bender assembly;

FIG. 2 shows a pipe bender head;

FIG. 3 shows a pipe bender adapter that may be used to connect an all-in-one handle to the pipe bender head;

FIG. 4A shows one example of the all-in-one handle;

FIG. 4B shows another example of the all-in-one handle;

FIGS. 5A-D show another example of the all-in-one handle;

FIGS. 6A-C show another example of the all-in-one handle;

FIG. 7A shows how the all-in-one handle may be coupled to differently sized pipe bender heads using adapters;

FIG. 7B shows the adapters integrated with the differently sized pipe bender heads;

FIG. 8 shows the all-in-one handle, the pipe bender heads, and the adapters stored in a portable casing; and

FIG. 9 shows a block diagram for a method on how to assemble and use the pipe bender assembly having the adapters and the all-in-one handle.

### DETAILED DESCRIPTION

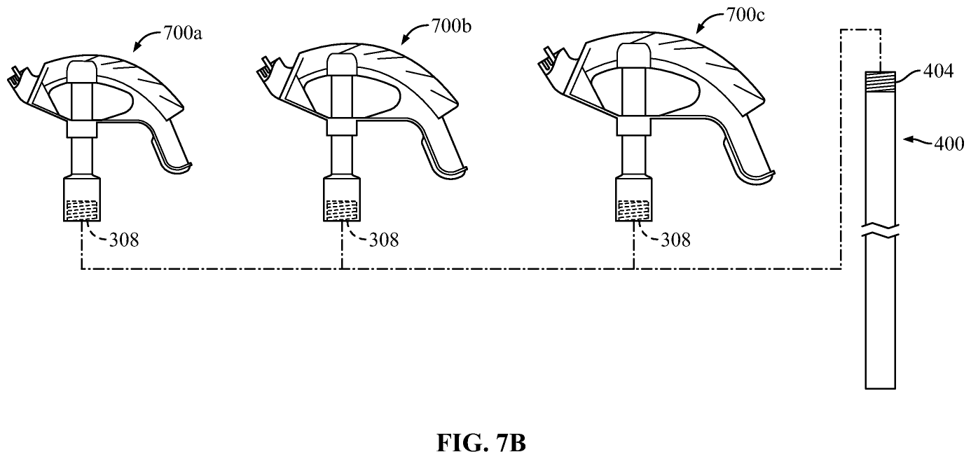

Referring now to the drawings, a pipe bender tool assembly 100 having an adapter 300 to couple a pipe bender head 200 to an all-in-one handle 400 is disclosed. As shown in FIG. 7A, pipe bender heads 200a-c may come in different sizes for bending pipes of various sizes. A single handle 400 may couple with the differently sized pipe bender heads 200a-c by using adapters 300a-b. Each adapter 300a-b may be configured to couple with a distinct coupling bore 202a-c of the pipe bender heads 200a-c and also couple with the coupling end 404 of the all-in-one handle 400. In this way, a user may only carry around the all-in-one handle 400 and the various adapters 300a-c instead of carrying multiple long and bulky handles that correspond to different pipe bender heads 200a-c. The pipe bender assembly 100 disclosed herein may pertain to electric metallic tube (EMT) pipe benders but is not limited to such pipe benders. The usage of the adapters and handles with other pipe benders or tools in general is also contemplated herein.

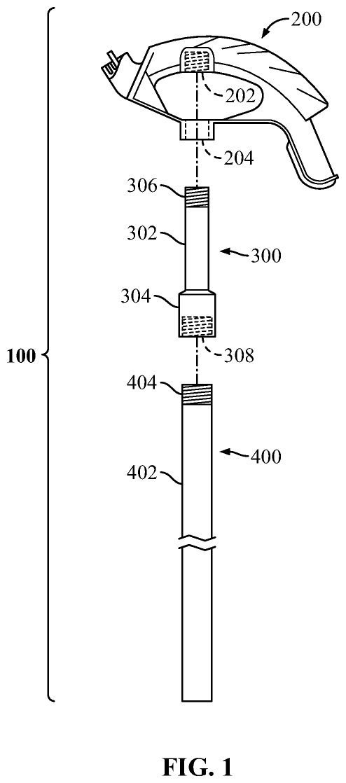

Referring specifically now to FIG. 1, the different components of a pipe bender assembly 100 is shown. The pipe bender assembly 100 may be used to bend EMT pipes by applying force to the pipe bender head 200. Typically, a user needs to carry a similar number of handles as the pipe bender heads since each regular handle is configured to connect with one or two specifically sized pipe bender head. As a result, the user may become encumbered with carrying and storing too many bulky tool parts on the project site. Consequently, a set of pipe bender adapters (see FIG. 7) like the adapter 300 shown in FIG. 1 may be used to couple one universal handle 400 to the differently sized pipe bender heads 200. Alternatively, the adapters may be used to couple an original handle of a larger sized pipe bender head to a smaller sized pipe bender head. By way of example and not limitation, the universal handle 400 may have the same dimensions as one of the larger sized original handles such that the adapter 300 may be used with both types of handles.

The adapter 300 may have a first mating section 302 that fits through the casing support 204 and couples with the coupling bore 202 of the pipe bender head 200. The first mating section 302 of the adapter 300 is sized specifically to couple with the coupling bore 202 of a pipe bender head 200 of a certain size. The adapter end 306 on the first mating section 302 and the coupling bore 202 of the pipe bender head 200 may have the same threading to fasten with each other. The adapter 300 may have a second mating section 304 to couple with a handle 400 that is configured to also couple with other adapters that have differently sized first mating sections 302 for connecting to different pipe bender heads 200. The second mating section 304 may couple to the handle 400 through screwing the coupling end 404 of the handle 400 in the receiving bore 308 of the second mating section 304. As a result, the coupling end 404 and the receiving bore 308 may have the same threading to fasten with each other, and the shaft 402 of the handle 400 having the coupling end 404 may have a size to fit snug inside the receiving bore 308 of the adapter 300. With the handle 400 connected to the pipe bender head 200 via the adapter 300, the user may apply force to the pipe bender head 200 and use the handle 400 as a leveraging tool for the pipe bender assembly 100 to bend the EMT pipe.

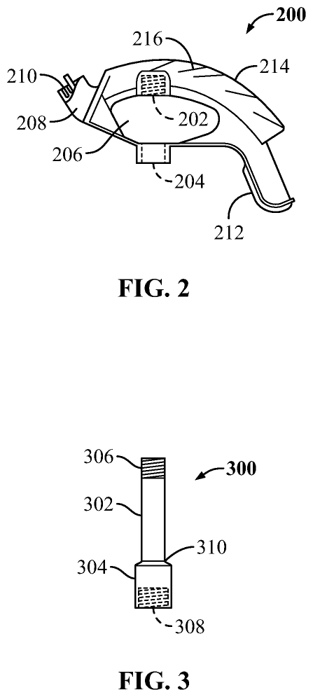

Referring now to FIG. 2, the pipe bender head 200 and its different components are shown. Although the pipe bender head 200 is primarily used to bend EMT pipes, it is also contemplated that other types of pipes may be bent by the pipe bender head 200. The pipe bender head 200 may come in different sizes depending on what size of pipe needs to be bent. As discussed with FIG. 7A, the pipe bender heads 200 may come in small, medium, and large sizes. By way of example and not limitation, the small size may correspond to bending an EMT pipe having a ½ inch diameter, the medium size may correspond to bending an EMT pipe having a ¾ inch diameter, and the large size may correspond to bending an EMT pipe having a 1-inch diameter. There may also exist an extra-large pipe bender head, which may correspond to bending an EMT pipe having a 1.25-inch diameter. The pipe bender head 200 may couple to a handle 400, in this case by using an adapter 300, where the handle 400 provides leverage in applying force to the bending mechanism of the pipe bender head 200.

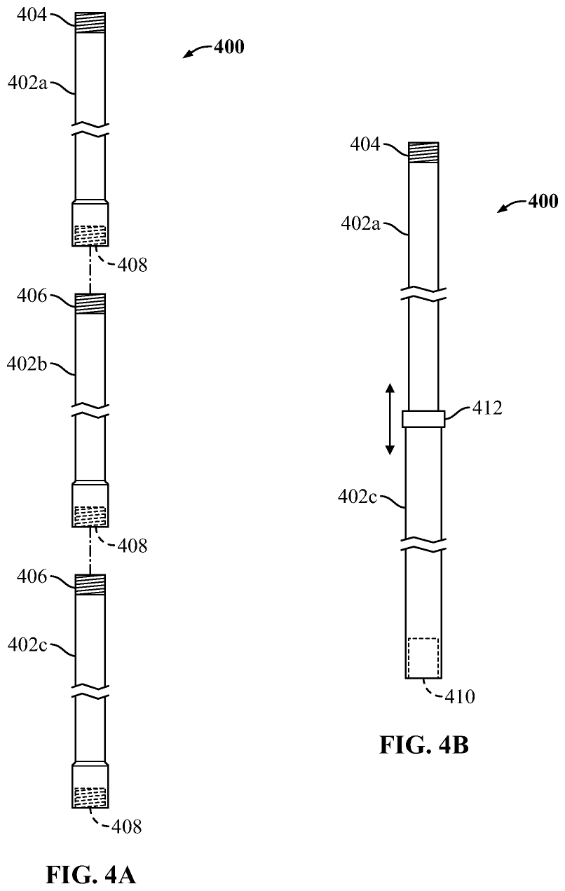

The pipe bender head 200 may have coupling components such as a coupling bore 202 and a casing support 204 to couple to a handle or, in this case, an adapter 300 (see FIG. 1) that in turn is coupled to an all-in-one handle 400. The coupling bore 202 and the casing support 204 may be holes that are aligned with each other between a through cavity 206 of the pipe bender head 200. In other examples, the pipe bender head 200 may not have a through cavity 206 and the coupling bore 202 and the casing support 204 may be integrated with each other. The coupling bore 202 may be located on an inner portion of the former 214 between the folding hook 210 and the foot press 212 of the pipe bender head 200. The coupling bore 202 may be threaded and have a distinct diameter size for use with a specific handle. The casing support 204 may be located under the coupling bore 202 and provide a through passage while also connecting the inlet portion 208 to the foot press 212 portion. Instead of receiving the specific handle, however, the coupling bore 202 and the casing support 204 may receive an adapter 300 (see FIG. 3) that in turn receives an all-in-one handle 400, as shown in FIG. 1. The coupling bore 202 and the casing support 204 may each have a diameter ranging from 0.25 to 1.5 inches. By way of example and not limitation, the small and medium pipe bender heads (see FIG. 7A) may have the same sized coupling bore 202 and casing support 204, and the large and extra-large pipe bender heads may have the same sized coupling bore 202 and casing support 204. Alternatively, each pipe bender head of different size may have its own distinct size of coupling bore 202 and casing support 202.

The bending mechanism of the pipe bender head 200 may have an inlet portion 208 where a straight pipe is inserted to be bent and shaped by the former 214. There may exist a folding hook 210 that clamps the inserted pipe by at least partially surrounding the pipe to keep the pipe aligned with the former 214 when force is applied to bend the pipe. The former 214 may be arc-shaped for the inserted pipe to be pressed against such surface and be bent. The former 214 may have angle markings 216 that gives the user an indicator of what angle the pipe would be bent if the bending reaches that arc point of the former 214. By way of example and not limitation, the angle markings 216 may have indicators for 30, 45, 60, and 90 degrees bent angles. The bending force may be applied to the pipe bender head 200 via the foot press 212. The foot press 212 provides a surface for the user to step on to provide force to bend the pipe along the former 214.

Referring now to FIG. 3, the pipe bender adapter 300 and its different components are shown. The adapter 300 may be generally cylindrical with a change in contour and thickness between the first and second mating sections 302, 304. By way of example and not limitation, the length of the adapter 300 may be between 4 to 12 inches, and the adapter may be made out of cast iron, aluminum alloy, steel alloy, intermediate metal conduit, or combinations thereof. The adapter 300 may be seen as having two major parts that ae the first mating section 302 and the second mating section 304, where the change in contour occurs between the transition section 310 of these two sections.

The first mating section 302 may be cylindrical shaped having a first mating end 306 to be inserted through the casing support 204 and be coupled to the coupling bore 202 of the pipe bender head 200, as shown in FIG. 1. As a result, the cross-sectional diameter size of the first mating section 302 and the first mating end 306 may be designed to be coupled inside the coupling bore 202 by substantially equaling the inner diameter size of the coupling bore 202, and the first mating end 306 may have the same threading as the coupling bore 202. Such diameter shaft size of the first mating section 302 may differ for different adapters 300 that are configured to couple with differently sized pipe bender heads 200, as shown in FIG. 7A. Similar to the coupling bore 202 and the casing support 204 (see FIG. 2), and by way of example and not limitation, the first mating section 302 may have a corresponding diameter size ranging from 0.25 to 1.5 inches. By way of example and not limitation, the length of the first mating section 302 may range between 2-10 inches.

The second mating section 304 may also be cylindrical shaped but may be thicker and extend more circumferentially outwards than the first mating section 302. The second mating section 304 may have a receiving bore 308 at its end designed to receive and couple with the coupling end 404 of the all-in-one handle 400, as shown in FIG. 1. As a result, the inner diameter size of the receiving bore 306 may be substantially equal to the diameter shaft size of the coupling end 404 of the handle 400 and have the same threading for fastening. Although FIG. 3 shows the threading of the receiving bore 308 spanning only the portion of the second mating section 304 closest to the opening of the receiving bore 308, the threading and the hole depth may extend further inside to cover the length of the second mating section 304. By way of example and not limitation, the depth of the threading of the receiving bore 308 may cover between ¼ to the whole length of the second mating section 304, depending on how secured the handle 400 needs to be to the adapter. Additionally, the threaded portion of the receiving bore 308 may be placed inwards at the end of the second mating section 304 closest to the transition section 310 of the adapter 300 so that the handle shaft 402 (see FIG. 1) is also received by the receiving bore 308 for better support between the components.

Unlike the first mating section 302, the inner diameter size of the receiving bore 306 of the second mating section 304 may be the same for different adapters 300 that are configured to couple with differently sized pipe bender heads 200, as shown in FIG. 7A. Keeping the inner diameter size the same may be required because the different adapters 300 may all be configured to couple with the same all-in-one handle 400. Instead of using the all-in-one handle 400, and as described elsewhere herein, the receiving bore 308 of the second mating section 304 may be designed to be used with the original handle of one of the pipe bender heads 200, specifically the handle of the large or extra-large pipe bender heads. As a result, the receiving bore 308 may have substantially the same inner diameter as the cross-sectional shaft diameter of the original handle of the large or extra-large pipe bender heads, which such original handles have shaft diameter sizes bigger than the original handles for the small and medium pipe bender heads. Additionally, the all-in-one handle 400 may have the same dimensions, specifically cross-sectional shaft diameter, as one of the original handles of the pipe bender heads such that the receiving bore 308 of the second mating section 304 may couple with both the all-in-one handle 400 and one of the original handles, specifically the handle of the large or extra-large pipe bender heads.

The handle 400 that is designed to couple with the second mating section 304 may have a larger cross-sectional diameter than the diameter of the coupling bore 202 (see FIG. 2). By way of example and not limitation, the inner diameter size of the receiving bore 308 may range between 0.5 to 1.75 inches. The second mating section 304 may taper and narrow towards the first mating section 302 around the transition section 310 due to the difference in thickness between the two sections. As mentioned elsewhere herein, the shaft of first mating section 302 equaling the diameter size of the distinct handle for the pipe bender head 200 may be designed to be smaller than the diameter of the all-in-one handle 400. By way of example and not limitation, the length of the second mating section 302 may also range between 2-6 inches.

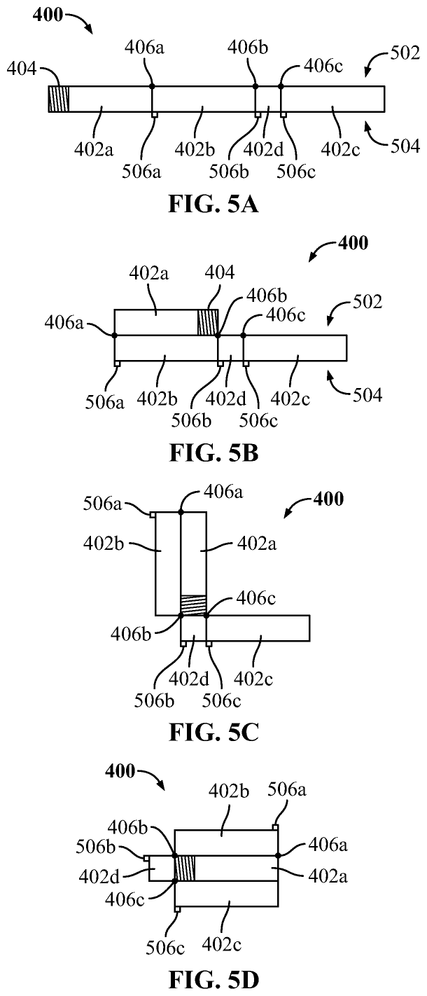

Referring now to FIG. 4A, an example of the all-in-one handle 400 is shown where the handle 400 has a plurality of modular parts. The plurality of modular parts of the handle 400 may be assembled and disassembled for the ease of carrying and storing the handle 400 and the pipe bender assembly 100 of FIG. 1. The handle 400 may be cylindrical and come in three pieces by having a leading shaft 402a, a middle shaft 402b, and a rear shaft 402c. By way of example and not limitation, the handle 400 may have a total length between 3 to 6 feet (preferably 44 inches) and be made from cast iron, aluminum, aluminum alloy, a steel alloy, intermediate metal conduit or combinations thereof. The leading shaft 402a may be between 1 to 2 feet long (preferably 14 U inches) and may have the coupling end 404 that is designed to couple with the second mating section 304 of the adapter 300, as shown in FIG. 1. The coupling end 404 may be threaded and have the same cross-sectional diameter size to fasten with the receiving bore 308 of the second mating section 304. By way of example and not limitation, the cross-sectional diameter size of the leading shaft 402a and the coupling end 404 may range between 0.5 to 1.75 inches. The leading shaft 402a may have a coupling socket 408 on the opposite end relative to the coupling end 404 to couple with the middle shaft 402b. The coupling socket 408 may be a threaded bore for the middle shaft 402b to screw inside. The coupling socket 408 may therefore be wider than the rest of the leading shaft 402a.

The middle shaft 402b may be between 1 to 2 feet long (preferably 14% inches) and may have a connecting end 406 that is designed to couple with the coupling socket 408 of the leading shaft 402a. The connecting end 406 of the middle shaft 402b may be threaded and have substantially the same diameter size as the coupling socket 408 of the leading shaft 402a to fasten to such component. The connecting end 406 may have the same, larger, or smaller cross-sectional diameter size as the coupling end 404 of the leading shaft 402a. By way of example and not limitation, the cross-sectional diameter size of the connecting end 406 and the middle shaft 402b in general may range between 0.5 to 1.75 inches. The middle shaft 402b may also have a coupling socket 408 similar to the coupling socket 408 of the leading shaft 402a to couple with the mar shaft 402c. The rear shaft 402c may be between 1 to 2 feet long (preferably 14% inches) and be the same as the middle shaft 402b by having a connecting end 406 and a coupling socket 408. The coupling socket 408 of the rear shaft 402c may be used to connect additional shafts to further lengthen the handle 400. Instead of the coupling socket 408, the rear shaft 402c may have an adjusting end 410 (see FIG. 4B) opposite of the connecting end 406 for the placement of a bent pipe inside such end to adjust the curvature of the bent pipe. The adjusting end 410 will be described in detail with further reference to FIG. 4B. Alternatively, the rear shaft 402c may merely have a regular shaft end instead of having a coupling socket 408 or an adjusting end 410. A proximal end of the rear shaft 402c may have an optional magnet attached thereto. During use, the user may turn the device upside down to pick up the pipe to be bent without having to bend over.

Referring now to FIG. 4B, another example of the all-in-one handle 400 is shown where the handle 400 is expanded and retracted through a telescoping mechanism. The handle 400 may be expanded and retracted for the case of carrying and storing the handle 400 and the pipe bender assembly 100 of FIG. 1. The handle 400 may have two modular pieces, where the leading shaft 402a may be retracted inside the rear shaft 402c via a telescoping mechanism. The rear shaft 402c may be hollow to receive the leading shaft 402a. The leading shaft 402a may be thinner than the rear shaft 402c such that the leading shaft 402a fits inside the rear shaft 402c. At the front end of the leading shaft 402a, there may exist the coupling end 404 that may be similar to the coupling end 404 of the other examples of the handle 400, described elsewhere herein. At the end of the rear shaft 402c that connects with the leading shaft 402a, them may exist a handle tightener 412 that can be rotated to fasten and unfasten and fix and unfix the position of the leading shaft 402a relative to the rear shaft 402c. At the rear end of the rear shaft 402c, there may exist an adjusting end 410 to place a bent pipe inside and adjust its curvature by applying force. After a user has bent a pipe using the pipe bender assembly 100 of FIG. 1, the user may use the adjusting end 410 to alter the bending of the pipe if such initial bending is not what the user wanted. The user may insert an end of the bent pipe inside the adjusting end 410 and provide a pulling or pushing force on the bent pipe to either unbend or further bend the curvature of the bent pipe. The handle 400 of FIG. 4B may have the same size and shape as described elsewhere herein and with respect to the other figures.

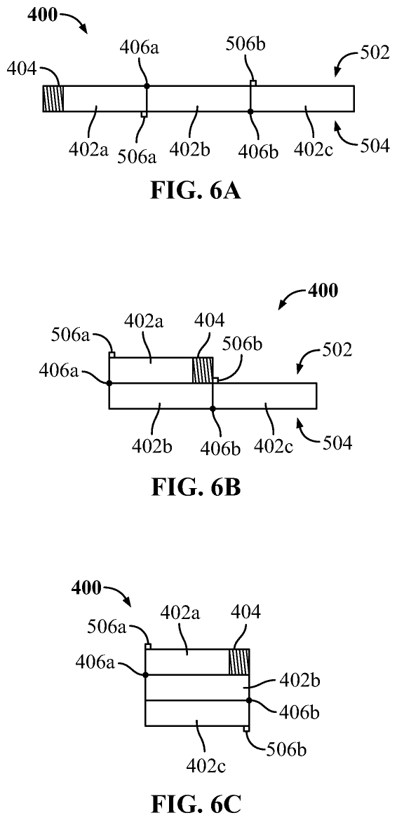

Referring now to FIGS. 5A-D, another example of the all-in-one, handle 400 is shown where the handle 400 is collapsible and extendable. The handle 400 may be collapsed and extended for the ease of carrying and storing the handle 400 and the pipe bender assembly 100 of FIG. 1. The handle 400 may be shortened by collapsing the modular shafts together using hinges 406a-c. In addition to the leading shaft 402a, the middle shaft 402b, and the rear shaft 402c, there may exist a junction shaft 402d in between the middle and rear shaft 402b, c. The handle 400 of FIGS. 5A-D may have a coupling end 404, an adjusting end 410 (see FIG. 4B), and may be the same size and shape as described elsewhere herein and with respect to the other figures. Alternatively, the cross-sectional area of the handle 400 may be cubical except for the coupling end 404 being cylindrical.

Referring specifically to FIG. 5A, the handle 400 in its extended state is shown. The leading shaft 402a may be connected to the middle shaft 402b by a first hinge 406a on a first longitudinal side 502 of the handle 400. The other end of the middle shaft 402b may be connected to the junction shaft 402d by a second hinge 406b on the first longitudinal side 502. The junction shaft 406d may be much smaller in length than the rest of the shafts of the handle 400. By way of example and not limitation, the junction shaft 406d may have a length approximately equal to the cross-sectional diameter or side height of the handle 400 shaft. Alternatively, the length of the junction shaft 406d may be between ⅓ to 1/10 the length of the other shafts. The other end of the junction shaft 402d may be connected to the rear shaft 402c by a third hinge 406c on the first longitudinal side 502 of the handle 400. As described elsewhere herein, each of the hinges 406a-c may rotate to collapse and rest the modular shafts of the handle 400 onto each other. The hinges 406a-c may all be located on the first longitudinal side 502 of the handle. There may exist latches 506a-c corresponding to the hinges 406a-c on a second longitudinal side 504 of the handle 400, where the second longitudinal side may be opposite to the first longitudinal side 502. The latches 506a-c may unlock and lock for the shafts 402a-d of the handle 400 to pivot about the hinges 406a-c to fold and unfold. Alternatively, the hinges 406a-c may have integrated locking mechanisms that prevent the modular shafts from folding and pivoting about the hinges 406a-c when in the extended form. Such integrated locking mechanisms may be unlocked when the user wants to fold and shorten the handle 400. The integrated locking mechanisms may also be activated in the folded position to keep the shafts folded together.

Referring specifically to FIG. 5B, the leading shaft 402a folding on the middle shaft 402b is shown. The first latch 506a may unlock for the leading shaft 402a to rotate about the first hinge 406a by approximately 180 degrees to fold on the first longitudinal side 502 portion of the middle shaft 402b. At this position, the first hinge 406a may lock into place to keep the leading shaft 402a folded on the middle shaft 402b.

Referring specifically to FIG. 5C, the leading shaft 402a and the middle shaft 402b folded about the second hinge 406b is shown. The second latch 506b may unlock for the middle shaft 402b along with the folded leading shaft 402a to rotate approximately 90 degrees about the second hinge 406b to fold relative to the junction shaft 402d. The folding may be such that the coupling end 404 of the leading shaft 402a rests on the first longitudinal side 502 portion of the junction rod 402d while also the leading shaft 402a being folded against the middle shaft 402b. At this position, the second hinge 406b may lock into place to keep the leading shaft 402a and middle shaft 402b folded on the junction shaft 402d.

Referring specifically to FIG. 5D, the modular shafts of the handle 400 being in a fully folded position is shown. The third latch 506c may unlock for the junction shaft 402d along with the folded leading shaft 402a and middle shaft 402b to rotate approximately 90 degrees about the third hinge 406c to fold relative to the rear shaft 402c. The folding may be such that the second longitudinal side 504 (see FIG. 5A-B) portion of the leading shaft 402a rests on the first longitudinal side 502 portion of the rear shaft 402c, with the leading and middle shafts 402a, b folded such that the first longitudinal side 502 portions of these shafts contacting each other. Also, the coupling end 404 of the leading shaft 402a may rest on the first longitudinal side 502 of the junction shaft 402d in this folded position. The second longitudinal side 504 may be opposite to the first longitudinal side 502. At this position, the third hinge 406c may lock into place to keep the leading shaft 402a and the middle shaft 402b folded and the junction shaft 402d and the rear shaft 402c locked into place.

The handle 400 may be unfolded similar to the steps of folding the collapsible handle 400 described elsewhere herein, specifically with reference to FIGS. 5A-D. When using the collapsible handle 400 to bend a pipe, the user may want to provide a pulling or pushing force directed from the first longitudinal side 502 towards the second longitudinal side 504. In this way, the applied bending force would be directed opposite to the pivoting directions of the hinges 406a-c connecting the handle shafts 402a-d such that the handle 400 would not unintentionally unlatch and fold when bending a pipe with the pipe bender assembly 100 (see FIG. 1).

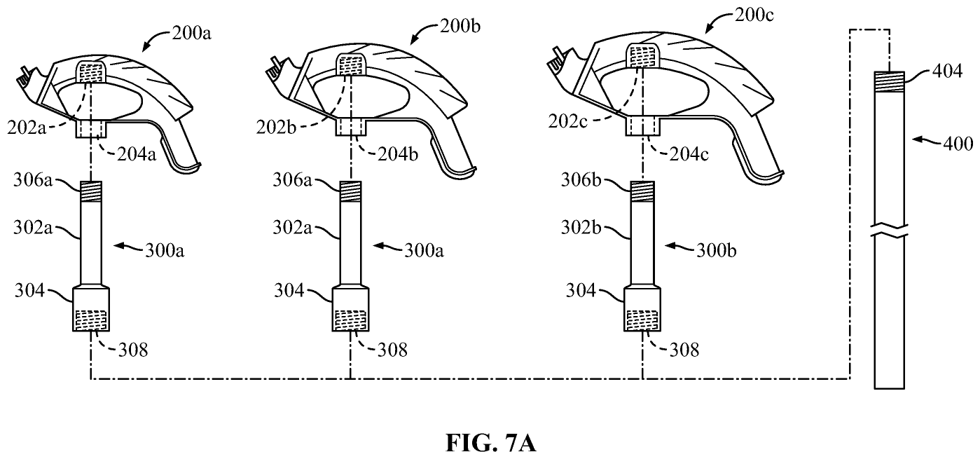

Referring now to FIGS. 6A-C, another example of the all-in-one handle 400 is shown where the handle 400 is collapsible and extendable. The handle 400 may be collapsed and extended for the ease of carrying and storing the handle 400 and the pipe bender assembly 100 of FIG. 1. The handle 400 may be shortened by collapsing the modular shafts together using hinges 406a-b. The handle 400 of FIGS. 6A-C may have a coupling end 404, an adjusting end 410 (see FIG. 4B), and may be the same size and shape as described elsewhere herein and with respect to the other figures. Alternatively, the cross-sectional area of the handle 400 may be cubical except for the coupling end 404 being cylindrical.

Referring specifically to FIG. 6A, the handle 400 in its extended state is shown. The leading shaft 402a may be connected to the middle shaft 402b by a first hinge 406a on a first longitudinal side 502 of the handle 400. The other end of the middle shaft 402b may be connected to the rear shaft 402c by a second hinge 406b on the second longitudinal side 504 of the handle 400. The second longitudinal side 504 may be opposite to the first longitudinal side 502 on the handle 400. There may exist a first latch 506a on the second longitudinal side 504 corresponding to the first hinge 406a and a second latch 506b on the first longitudinal side 502 corresponding to the second hinge 406b. The latches 506a-b may unlock and lock for the shafts 402a-c of the handle 400 to pivot about the hinges 406a-b to fold and unfold. Alternatively, the hinges may have integrated locking mechanisms similar to what has been described elsewhere herein, specifically with FIGS. 5A-D.

Referring specifically to FIG. 6B, the leading shaft 402a folding on the middle shaft 402b is shown. The first latch 506a may unlock for the leading shaft 402a to rotate about the first hinge 406a by approximately 180 degrees to fold on the first longitudinal side 502 portion of the middle shaft 402b. At this position, the first hinge 406a may lock into place to keep the leading shaft 402a folded on the middle shaft 402b.

Referring specifically to FIG. 6C, the modular shafts of the handle 400 being in a fully folded position is shown. The second latch 506b may unlock for the rear shaft 402c to rotate about the second hinge 406b by approximately 180 degrees to fold on the second longitudinal side 504 portion of the middle shaft 402. At this position, the second hinge 406b may lock into place to keep the rear shaft 402c folded on the middle shaft 402b. With the leading shaft 402a also folded on the middle shaft 402b, the handle 400 is fully folded and configured to be transported and stored with ease.

Referring now to FIG. 7A, the all-in-one handle 400 having one size that is designed to couple to differently sized pipe bender heads 200a-c using the pipe bender adapters 300a-b is shown. The second mating sections 304 of the adapters 300a-b may each have the same size for coupling with the all-in-one handle 400, while each adapter 300a-b may also have a specifically sized first mating section 302a-b to couple with a pipe bender head 200a-c of a particular size. Pipe bender heads 200a-c may come in one or more sizes, such as small 200a, medium 200b, large 200c, and extra-large (not shown). By way of example and not limitation, the small pipe bender head 200a may correspond to ½ inch diameter pipes, the medium pipe bender head 200b may correspond to ¾ inch diameter pipes, the large pipe bender head 200c may correspond to 1 inch diameter pipes, and the extra-large pipe bender head may correspond to 1.25 inch diameter pipes. These differently sized pipe bender heads 200a-c may have coupling bores 202a-c of different sizes to couple to a specific handle. By way of example and not limitation, the small and medium pipe bender heads 200a-b may have coupling bores 202a-b of the same dimensions such that these pipe bender heads 200a-b were originally designed to couple to the same handle having a particular cross-sectional area. Similarly, the large pipe bender head 200c and the extra-large pipe bender head (not shown) may have been designed to couple to a same handle having a particular cross-sectional area larger than the handle used for the small and medium pipe bender heads 200a-b. Instead of using differently sized handles, different adapters 300a-b corresponding to the differently sized pipe bender heads 200a-c may be used to connect a single all-in-one handle 400 to all the pipe bender heads 200a-c separately. Alternatively, the original handle of the large and extra-large pipe bender heads may be used with an adapter 300a to couple to the small and medium pipe bender heads.

The adapters 300a-b may come in small 300a, large 300b, and extra-large (now shown) sizes corresponding to the sizes of the pipe bender heads 200a-c. The first mating sections 302a-b of each adapter 300a-b may be shaped to couple to a pipe bender head 200a-c having a specific size. For instance, the small adapter 300a may have a first mating section 302a having a first mating end 306a in a form of a shaft that is sized and threaded to be fastened inside the coupling bore 202a of the small pipe bender head 200a. By way of example and not limitation, the small adapter 300a may also be used with the medium pipe bender head 200b if such pipe bender head has the same dimensioned coupling bore 202b and casing support 204b as the small pipe bender head 200a. Alternatively, the medium pipe bender head 200b may have a differently dimensioned coupling bore 202b and casing support 204b than the small pipe bender head 200a, which would require an adapter having a first mating section designed for the different size of the coupling bore 202b. Similarly, the large adapter 300b may have a first mating section 302b having a first mating end 306b for coupling inside the coupling bore 202b of the large pipe bender heads 200. The cross-sectional diameter size of the first mating end 306b of the first mating section 302b of the large adapter 300b may be greater than the first mating end 306a of the first mating section 302a of the small adapter 300a. By way of example and not limitation, the large adapter 300b may also be used with the extra-large pipe bender head (not shown) if such pipe bender head has the same dimensioned coupling bore and casing support as the large pipe bender head 200c. Alternatively, the extra-large pipe bender head (not shown) may have a differently dimensioned coupling bore than the large pipe bender head 200c, which would require an adapter having a first mating section designed for the different size of the extra-large coupling bore.

Although the first mating sections 302a-b of the differently sized adapters 300a-b differ in size, the second mating sections 304 of the differently sized adapters 300a-b may have the same size because each of them am configured to couple with the same sized all-in-one handle 400. As a result, the receiving bore 308 of each adapters 300a-b may be sized and threaded in the same way to couple with the coupling end 404 of the all-in-one handle 400. In this way, the user may now carry differently sized adapters 300a-b instead of differently sized handles, which would be less cumbersome since the adapters 300a-b am much smaller and lighter than the handles. Although the all-in-one handle 400 is illustrated as one long shaft in FIG. 7A, the handle 400 may actually be in the form of what is disclosed in FIGS. 4-6. Additionally, the handle 400 may be longer than what is shown in FIG. 7A. Instead of using the all-in-one handle 400, and as described elsewhere herein, the adapters 300a-b may be designed to be used with the original handle of one of the pipe bender heads 200a-c, specifically the handle of the large or extra-large pipe bender heads. As a result, the other handles of the other pipe bender heads of different sizes may be discarded. The all-in-one handle 400 may have the same dimensions, specifically cross-sectional shaft area, as one the original handles of the pipe bender heads such that the adapters 300a-b may be used with both the all-in-one handle and one of the original handles, specifically the handle of the large or extra-large pipe bender heads.

Referring now to FIG. 7B, the features of the adapters 300a-b(see FIG. 7A) integrated with the pipe bender heads 700a-c is shown. The differently sized pipe bender heads 700a-c may all have the same size receiving bore 308 integrated in their structure to couple with the all-in-one handle 400. As a result, the differently sized pipe bender heads 700a-c do not require a distinct handle for use, and instead of carrying separate adapters 300a-b like FIG. 7A, the differently sized pipe bender heads 700a-c may each have the same sized receiving bore 308 to connect with the same handle 400 even though the heads differ in size.

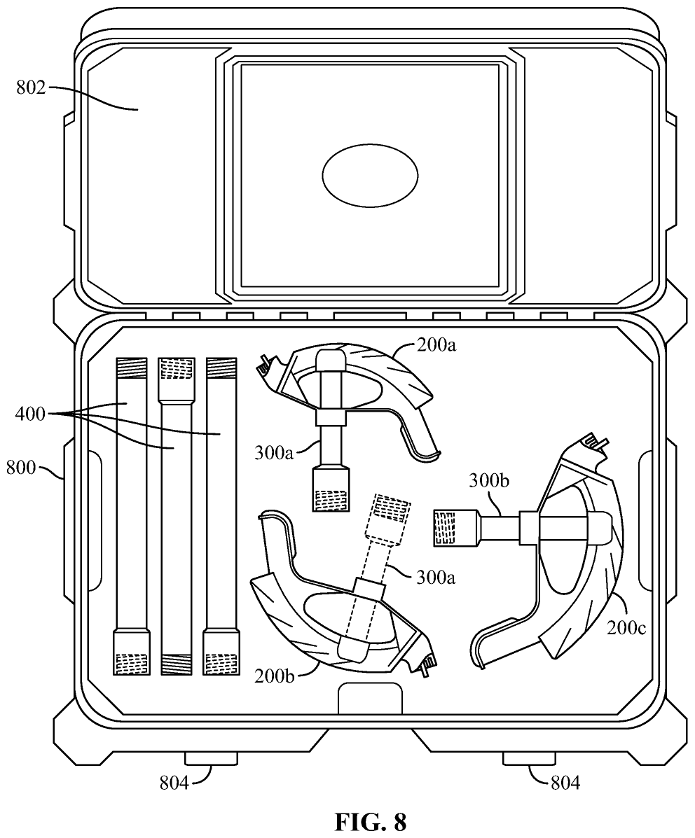

Referring now to FIG. 8, a portable casing 800 that may be used to store the different components of one or more pipe bender assemblies 100, like the one shown in FIG. 1, is shown. The casing may be spacious enough to store the modular handle 400 and the differently sized pipe bender adapters 300a-b and pipe bender heads 200a-c. The casing 800 may also have a lid 802 with one or more locks 804 to enclose the components of the pipe bender assembly 100 inside the casing 800.

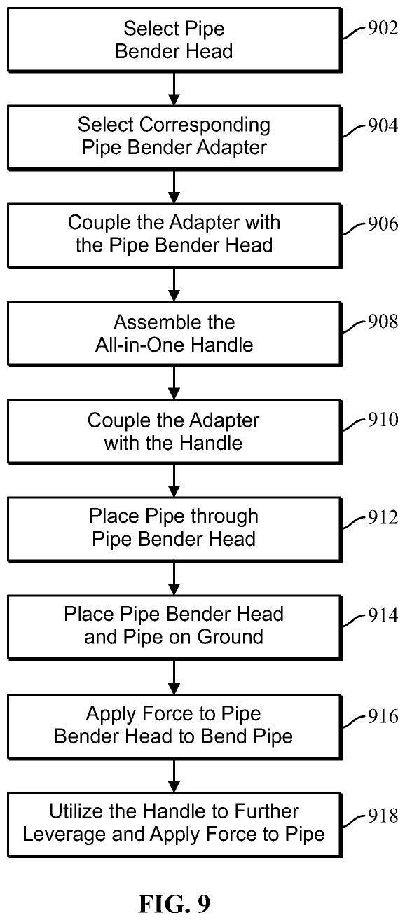

Referring now to FIG. 9, a block diagram for a method on how to use the pipe bender assembly 100 of FIG. 1 is shown. In block 902, the user selects the correct sized pipe bender head 200a-c (see FIG. 7A) for bending a pipe having a specific diameter. The pipe bender head 200 that the user selects may have the features and components described elsewhere herein. In block 904, the user selects the corresponding adapter 300a-b (see FIG. 7A) that may be coupled to the pipe bender head 200a-c and the all-in-one handle 200. This may be done by matching the size of the first mating section 302 of the selected adapter 300 with the coupling bore size 202 of the selected pipe bender head 200. The adapter 300 that the user selects may have the features and components described elsewhere herein. The pipe bender head 200, adapter 300, and handle 400 may be in the casing 800 shown in FIG. 8, and so the user may have to open and grab such components from the casing 800. In block 906, the user displaces the first mating section 302 (see FIG. 1) of the adapter 300 through the casing support 204 of the pipe bender head 200 and couples the adapter end 306 of the first mating section 302 with the coupling bore 202 of the pipe bender head 200. If the pipe bender head does not have a casing support 204 section, then the user may simply couple the adapter end 306 to the coupling bore 202 of the pipe bender head 200. In block 908, the user may assemble the all-in-one handle 400. The handle 400 may have the features and components described elsewhere herein. In block 910, the user may couple the handle 400 to the second mating section 304 by screwing the coupling end 404 inside the receiving bore 308.

In block 912, the user may place the conduit pipe through the inlet portion 208 of the pipe bender head 200 (see FIG. 2) so that the folding hook 210 would surround a portion of the pipe that will be bent. In block 914, the user may turn and place the former 214 of the pipe bender head 200 along with the pipe on the ground. In block 916, the user may apply force with his or her foot on the foot press 212 of the pipe bender head 200 (see FIG. 2) to roll the former 214 along the floor in order to bend the pipe. In block 918, the user may utilize the handle 400 to further leverage and apply force in bending and shaping the pipe. After the user is finished bending the pipe, the user may uncouple the handle 400 from the selected adapter and pipe bender head and couple the handle 400 to a different adapter to bend a second pipe that has a different size.

The above description is given by way of example, and not limitation. Given the above disclosure, one skilled in the art could devise variations that am within the scope and spirit of the invention disclosed herein. Further, the various features of the embodiments disclosed herein can be used alone, or in varying combinations with each other and am not intended to be limited to the specific combination described herein. Thus, the scope of the claims is not to be limited by the illustrated embodiments.

What is claimed is:

1. A method for assembling a pipe bender tool for bending a pipe, comprising:
providing a plurality of pipe bender adapters, a plurality of pipe bender heads with each pipe bender head capable of bending a different size pipe and attachable to a corresponding pipe bender adapter, a universal handle attachable to each of the plurality of pipe bender adapters;
selecting a desired pipe bender head from the plurality of pipe bender heads that fits the pipe;
selecting a desired adapter from the plurality of pipe bender adapters that fits the selected pipe bender head;
coupling a first mating section of the selected adapter to a coupling bore of the selected pipe bender head, the first mating section having a mating end portion that is threaded and cylindrical to couple with the coupling bore; and
coupling a second mating section of the desired adapter with a coupling end of the universal handle, the second mating section having a receiving bore that is threaded to couple with the coupling end of the universal handle.

2. The method of claim 1, further comprising assembling a first modular shaft with a second modular shaft of the universal handle by coupling a connecting end of the second modular shaft with a coupling socket of the first modular shaft prior to coupling the selected adapter with the universal handle.

3. The method of claim 1, further comprising unfolding a first shaft from a second shaft of the universal handle through rotation about a first hinge of the universal handle and unfolding the second shaft from a third shaft through rotation about a second hinge of the universal handle prior to coupling the selected adapter with the universal handle.

4. The method of claim 1, further comprising expanding the universal handle through a telescoping mechanism.

5. The method of claim 1, further comprising uncoupling the universal handle from the selected adapter and coupling the universal handle to a different second mating section of a second selected adapter.

6. The method of claim 1, wherein the selecting of the selected adapter is done by matching a size of the first mating section of the selected adapter with a hole size of the coupling bore of the selected pipe bender head.

7. The method of claim 1, further comprising inserting the mating end portion of the selected adapter through a casing support hole of the selected pipe bender head prior to coupling the mating end portion to the coupling bore.

8. The method of claim 7, wherein the coupling bore and the casing support hole am located between a pipe inlet portion and a foot press portion of the selected pipe bender head.

9. The method of claim 1, wherein the plurality of pipe bender adapters is metallic.

10. The method of claim 3, wherein the universal handle is metallic.

11. An assembly of a plurality of pipe bender adapters and a universal handle, comprising:
a first adapter having a first mating section that is cylindrical and having a first adapter end that is threaded and dimensioned to couple to a first coupling bore of a first pipe bender head, and the first adapter having a second mating section having a first receiving bore that is threaded and dimensioned to couple with the universal handle;
a second adapter having a first coupling section that is cylindrical and having a second adapter end that is narrower than the first adapter end of the first adapter and threaded and dimensioned to couple to a second coupling bore of a second pipe bender head having a smaller bore size than the first pipe bender head, and the second adapter having a second coupling section having a second receiving bore having a same size as the first receiving bore of the first adapter; and
the universal handle being modular and having a first and a second shaft, the first shaft having a coupling end configured to couple with the first and the second receiving bores of the first and the second adapters.

12. The assembly of claim 11, wherein the second shaft of the universal handle has a connecting end to couple with a coupling socket of the first shaft of the universal handle.

13. The assembly of claim 11, wherein the first shaft of the universal handle is connected to the second shaft of the universal handle by a first hinge configured to allow the first shaft to rotate and fold on the second shaft, and a third shaft of the universal handle connected to the second shaft by a second hinge.

14. The assembly of claim 13, wherein the folded first shaft and the second shaft are configured to rotate about the second hinge such that the coupling end of the first shaft lies on the third shaft.

15. The assembly of claim 14, wherein the third shaft is connected to a fourth shaft by a third hinge such that the first and the second shafts are configured to rotate and fold on the fourth shaft.

16. The assembly of claim 11, wherein the first shaft is configured to retract inside the second shaft through a telescoping mechanism.

17. The assembly of claim 11, wherein the second shaft of the universal handle has an adjusting end for receiving bent pipes.

18. The assembly of claim 11, wherein the plurality of pipe bender adapters and the universal handle are configured to be stored in a portable casing.

19. The assembly of claim 11, wherein the plurality of pipe bender adapters is metallic.

20. The assembly of claim 11, wherein the universal handle is metallic.
